(19) United States
(12) Patent Application Publication
(10) Pub. No.: US 2011/0135061 A1
(43) Pub. Date: Jun. 9, 2011

(54) DEVICE AND METHOD FOR ANALYZING NANOPARTICLES BY COMBINATION OF FIELD-FLOW FRACTIONATION AND X-RAY SMALL ANGLE SCATTERING

(76) Inventor: Andreas Thünemann, Berlin (DE)

(21) Appl. No.: 12/993,623

(22) PCT Filed: May 20, 2009
(86) PCT No.: PCT/EP2009/056110

§ 371 Date: Feb. 4, 2011

(30) Foreign Application Priority Data
May 21, 2008 (DE) 102008024739.1

(51) Int. Cl. G01N 23/201; B82Y 35/00

(52) U.S. Cl. 378/88; 378/86; 977/773; 977/880

(57) ABSTRACT

The invention relates to a method and to an apparatus for analyzing nanoparticles, wherein the nanoparticles are first fractionated as a function of their particle size and subsequently analyzed, wherein small angle X-ray scattering is used for the analysis of the nanoparticles, and to a corresponding apparatus for carrying out the method according to the invention. The analysis by means of small angle X-ray scattering comprises the focussing of X-radiation onto the nanoparticles to be analyzed by means of a slit collimator and the analysis of the nanoparticles using a detector-to-sample distance of less than 50 cm.

The invention relates to an apparatus and a method for analyzing nanoparticles, wherein the nanoparticles are first fractionated as a function of their particle size and subsequently analyzed.

Nanoparticles play a central economic role in the development of nanotechnology. This relates to classic fields, such as colloid and polymer chemistry, and also to new developments with economic applications, ranging from solar cells via organ-specific drug delivery systems and gene therapy to cancer diagnosis.

In addition to their benefits, the potential dangers nanoparticles pose to human health and to the environment have become increasingly apparent and the subject of controversial discussions. The analysis of nanoparticles regarding their central physicochemical size is a fundamental basis for a rationally and scientifically substantiated assessment of the risk potential of nanoparticles. The same is true for the systematic technical development of the application of nanoparticles in technical processes and components, catalysts, food additives and pharmaceutical formulations. Nanoparticles with particle diameters of less than 100 nm are of particular importance.

There have therefore been many attempts at developing methods for the analysis of nanoparticles. Of these, two methods have proven especially successful, specifically electron microscopy and dynamic light scattering.

Imaging methods, such as scanning electron microscopy and transmission electron microscopy are used extensively in the analysis of nanoparticles. The inherent disadvantages thereof are the rather random selection of a limited number of nanoparticles instead of a selection which is representative of the entire sample, the time-consuming sample preparation and the high probability of producing systematic measurement artifacts. It is known, for example, that conventional stabilizers in the form of polymeric surfactants can completely cover the nanoparticles to be investigated in the analyses. Furthermore, in situ measurements are not possible with the electron microscopy because the nanoparticles must be in a vacuum for the analysis.

Methods such as dynamic or static light scattering give mean values or sum parameters over the entire sample. In monodisperse samples or samples with a narrow size distribution (standard deviation of less than 10%), this gives very good results. The advantage here is that the results obtained are representative of the entire sample.

Dynamic light scattering is the dominant technique for analyzing nanoparticles in the range of 100 to 500 nm. Its operation is non-invasive and non-destructive. Dissolved or dispersed nanoparticles can be measured within a few minutes. The central problem of dynamic light scattering is, however, the underlying physical measurement principle. Statements relating to the particle size are derived from the actual measurement size, from what is referred to as effective z mean value of the diffusion coefficient of the nanoparticles.

In spherical nanoparticles, the diffusion coefficient is inversely proportional to the radius. Size determination using dynamic light scattering becomes difficult, however, when traces of dust are present in the sample or proportions of the nanoparticles are present in aggregate form, in clumps, as it were, which occurs very frequently. Moreover, dynamic light scattering is unable to provide statements relating to further physicochemical parameters, and its use is therefore limited to determining the mass of the nanoparticles.

In addition, a number of assumptions are necessary when size distributions are present, that is to say when the nanoparticles do not have a uniform size. In that case, the analysis results are either of no use, represent a rough estimate or are ambiguous. This is also the reason why ISO standard 13321 limits the standardized applicability of dynamic light scattering to nanoparticles with uniform size. Typically, the so-called “cumulant analysis” (Frisken, B. J., Applied Optics 2001, 40, (24), 4087-4091) is reliable only for a polydispersity index of less than 0.1, which is comparatively rare in analytic practice. Therefore, fractionation of the samples to be analyzed is absolutely necessary if the aim is to ascertain detailed information relating to the size distribution.

Fraunhofer W. et al. first describe such a method, in which drug carriers on the basis of gelatine nanoparticles are first divided using field-flow fractionation and are then analyzed using multi-angle light scattering (MALS) (Fraunhofer W. et al., Anal. Chem., 76(7), 1909-1920, 2004).

However, dynamic light scattering is limited to nanoparticles of 100 nm or less due to the relation of the wavelength used for the measurement to particle size. It is also not possible to use dynamic light scattering to analyze further physicochemical parameters in addition to the size of the nanoparticles, such as shape, structure or surface finish.

One measurement method operating at a significantly shorter wavelength is small angle X-ray scattering. Small angle X-ray scattering is a method that is already used also for determining the size, shape, number and internal structure of nanoparticles in solution. However, the interpretation of data is often ambiguous, for example if the nanoparticles are present in polydisperse form or have different shapes, for example if spherically symmetrical or cylindrically symmetrical nanoparticles are present in a sample. The reason for this is that small angle X-ray scattering automatically averages the scattering contributions of all the nanoparticles in the solution in terms of time and space, that is to say is representative of the entire sample.

Overall, the scatter intensity obtained, compared to dynamic light scattering, is smaller by the factor 1,000,000, which clearly limits the application of the method. The attempt to combine such a method with a fractionation of particles must therefore be classified as not technically feasible, since the measurable intensity of the small angle X-ray scattering signal after fractionation of nanoparticles is much too small for any detection to still be possible. Extending the measurement time to the range of several hours or days is not acceptable in the field of nanotechnology. Moreover, it is important particularly in biotechnology and medical technology that the signal-to-noise ratio does not become too small for reliable statements relating to the composition and nature of nanoparticles to be made.

Since technically relevant nanoparticles are typically present not in monodisperse but in polydisperse form, complicated analyses using different methods must be carried out to characterize them, often leading to contradictory results.

There is therefore the need to make available a method, in which, in addition to the size of nanoparticles, further physicochemical parameters can be analyzed reliably and measurement of nanoparticles even of less than 100 nm is also possible. Here, the measurements should be capable of being made in solution and the measurement times should be kept as short as possible.

Surprisingly, it was possible to overcome the problems described in the prior art and to provide a method having the feature of claim 1, which enables the division of nanoparticles on the basis of their particle size and subsequently their analysis using small angle X-ray scattering. Preferred embodiments of the method are characterized in the dependent claims.

The invention relates to a method for analyzing nanoparticles, comprising fractionation of the nanoparticles to be analyzed as a function of their particle size and, immediately following, an analysis of the nanoparticles using small angle X-ray scattering. The problem of scatter intensities, which are too small, in fractionated nanoparticle samples was solved here by the analysis by means of small angle X-ray scattering comprising the focussing of X-radiation onto the nanoparticles to be analyzed by means of a slit collimator and the analysis of the nanoparticles using a detector-to-sample distance of less than 50 cm.

Furthermore, the scatter intensities can be increased by combining intensive X-radiation, preferably synchrotron radiation, with a small angle X-ray scattering system optimized for nanoparticles. In this manner it is possible to obtain sufficient scatter intensities in measurement times of up to less than one second.

The method according to the invention enables time-saving and precise characterization of dispersed nanoparticles from chemical-technical processes. The method is here always particularly advantageously applicable for analysis purposes if mixtures of nanoparticles having varying size, shape and/or structure are intended to be investigated.

Within the context of this invention, nanoparticles are understood to refer to particles of any material, whose particle size lies within the range of 1 to 300 nm, preferably of 1 to 100 nm and particularly preferably of 1 to 50 nm. The nanoparticles can be composed of synthetic and/or natural materials. The nanoparticles can preferably be present as individual particles or as aggregates, compounds or composites. In particular, nanoparticles are also individual molecules, i.e. macromolecules, or aggregates of a plurality of low-molecular substances. The nanoparticles can have any desired form. Natural materials are to be understood to mean in particular peptides and proteins.

Fractionation of the nanoparticles as a function of the particle size can be effected using any of the fractionation methods known to the person skilled in the art. The nanoparticles are preferably divided on the basis of their diffusion coefficients. Used here, in particular, is fractionation by means of a method from the group of field-flow fractionations. The field-flow fractionation methods enable gentle fractionation of nanoparticles according to their size, wherein, compared to the gel-permeation chromatography, the high-pressure liquid chromatography (HPLC) or the analytic ultracentrifugation for example, the nanoparticles are subjected to only low shear forces.

This ensures that the nanoparticles are not damaged or even destroyed by the fractionation. As a result, field-flow fractionation is suitable also for sensitive nanoparticles, such as biomolecules, in particular proteins. According to the invention, asymmetrical field-flow fractionation is preferably carried out.

A further object of the invention is an apparatus for carrying out the method according to the invention having the features of independent claim 11. Preferred embodiments are characterized in the dependent claims.

The invention relates to an apparatus for analyzing nanoparticles, comprising a device for fractionation and a device, connected downstream, for analyzing nanoparticles, wherein the device for fractionation is a device for fractionating on the basis of the particle size and the device for analysis is a device for measuring small angle X-ray scattering. The detector-to-sample distance in the device for measuring small angle X-ray scattering is here less than 50 cm and the device for measuring small angle X-ray scattering has a slit collimator.

The detector-to-sample distance is preferably less than 30 cm.

The optimization according to the invention of the device for measuring small angle X-ray scattering for nanoparticle analysis thus includes the significant reduction of the detector-to-sample distance. Since the scatter intensity decreases with the square of the distance, this significant reduction with respect to the usual detector-to-sample distances in small angle X-ray scattering systems of about 1 to 2 m is of critical importance for the applicability of small angle X-ray scattering in nanoparticle analysis.

Compared with the typically used dot collimator, a larger sample volume is also illuminated due to the slit collimator and an increase in the scatter intensity is likewise achieved, which allows further reduction of the measurement time.

If the slit collimator is used, the signal pattern obtained is composed of a superposition of adjacent dot signal patterns and folds itself, as it were. The resulting “smearing” can be removed by calculation for evaluation of the data by means of suitable deconvolution software.

In one preferred embodiment, the device for fractionation on the basis of the particle size is a device for fractionation on the basis of the diffusion coefficient. Here, all devices for fractionation known to the person skilled in the art can be used. For reasons of gentle division, a device for field-flow fractionation is preferably used.

In a particularly preferred embodiment, the device for measuring the small angle X-ray scattering has a through-flow capillary. This enables the previously divided sample material to be fed to and removed from the small angle X-ray scattering system. In particular, compared to typical devices for measuring small angle X-ray scattering, there is no longer any need for melting the sample in a suitable measurement capillary or for the time it takes to re-establish the vacuum in the measurement chamber.

In another embodiment, an X-ray source of the device for measuring small angle X-ray scattering can be any desired X-ray source emitting high-energy X-radiation. The device for measuring small angle X-ray scattering preferably has a means for monochromatization of X-rays. Means for monochromatization are known to the person skilled in the art. According to the invention, preferably a Goebel mirror is used for monochromatization. Advantageously, an intensity increase of up to ten times is achieved by means of the Goebel mirror owing to the collimation of the X-ray according to the invention.

In a further advantageous embodiment of the invention, a UV detector is positioned between the device for fractionation of the nanoparticles and the device for measuring small angle X-ray scattering.

It is possible, using the apparatus according to the invention, to continuously measure particle samples. The method according to the invention is therefore characterized in particular in that the fractionation of the nanoparticles and/or the subsequent analysis is/are continuous. The sample material, preferably polydisperse nanoparticles, are divided in the device for fractionation and automatically passed on to the device for measuring small angle X-ray scattering. The sample material here reaches the small angle X-ray scattering system in fractions and can, after the analysis, be collected in fractions together with the flow medium or discarded. During the analysis of the final fraction, the device for fractionation can already divide the next sample.

The additional UV detector is advantageous especially for series of tests. If UV active sample material, such as protein-containing or dyed nanoparticles, is used, the sample fractions are detected at the UV detector before reaching the capillary in the small angle X-ray scattering system. This signal can be coupled, for example, with a fraction collector, which collects the analyzed fractions downstream of the small angle X-ray scattering system. The time delay between the signal at the UV detector and the scatter signal from the small angle X-ray scattering system must be taken into account here and can be matched to the individual test conditions by appropriate selection of the flow rate in the system and the flow path.

It is possible with the method according to the invention to investigate various physicochemical parameters of the nanoparticles. Preferably investigated are the size, mass, shape, number, material composition, internal structure and/or coating of the nanoparticles. With less time, it is possible here to investigate a plurality of parameters at the same time. This can be considered one of the main advantages over other methods, such as light scattering. Especially in the field of biotechnology, the analysis of the size of the particles is often not enough. By way of example, denatured proteins in dynamic light scattering can yield the same signals as protein dimers. In protein-based medicaments, however, denatured proteins would be ineffective, and therefore structure elucidation represents an important parameter when analyzing bioparticles. In particular, it is also possible to make statements relating to the internal structure of the nanoparticles, for example core-shell structures, and to their stabilization (steric, electrostatic etc.).

In another embodiment of the method according to the invention, interactions among the nanoparticles are additionally analyzed, in particular the hard sphere potential, the screened Coulomb potential or the 2-Yukawa potential.

High-energy, monochromatic X-radiation is preferably used for the method according to the invention. The photon energy preferably lies within the range of 5 keV to 80 keV, particularly preferably within the range of 8 keV to 15 keV. In a particularly preferred embodiment, synchrotron radiation is used for measuring the small angle X-ray scattering.

Surprisingly, synchrotron radiation could be used for the method according to the invention. Synchrotrons typically operate with dot collimators, such that the achieved scatter intensity is too low for the analysis of nanoparticles. It is only in combination with the apparatus according to the invention that synchrotron radiation can be used effectively. Advantageously, the synchrotron radiation is already monochromatic, so that the monochromatization step, which is associated with a loss of intensity, can be dispensed with. The X-radiation preferably used has a wavelength of λ=0.154 nm.

The use of X-radiation also has the advantage that the problem of impurities, which usually occurs for example in dynamic light scattering, no longer play a role. In measurement methods operating with visible light, dust and similar impurities falsify the measurement result to a great extent. Therefore, sample preparation is subject to strict requirements. In particular, centrifugation and filtration methods are used to remove impurities. This is also associated with, in addition to an increase in time, the problem that sample material can be lost during the purification steps or the size distribution or structure distribution of the sample is falsified.

If the small angle X-ray scattering is used according to the invention, dust and impurities only play a minor role. A scatter signal which may be produced by impurities would lie within the range that is filtered out by the primary beam catcher.

The method according to the invention is characterized especially by a short measurement time and thus a high sample through-put. This is very important especially for industrial application in the field of high-through-put methods. According to the invention, the measurement time for the analysis of a fraction is less than 10 seconds, preferably less than 1 second, and is limited only by the speed of the detector. It is furthermore advantageous that the samples for analysis can be measured directly in solution, without the need for further sample preparation.

Nanoparticles within the meaning of the invention are understood to mean inorganic and organic materials and composites of both, synthetic and natural materials and composites of both, in particular proteins and their composites with the aforementioned materials. The nanoparticles preferably have a size of 1 to 300 nm, preferably of 1 to 100 nm and particularly preferably of 1 to 50 nm.

### SUMMARY OF THE FIGURES

FIG. 1A shows a schematic illustration of the apparatus according to the invention.

FIG. 1B schematically shows how field-flow fractionation works.

FIG. 2 shows Guinier fitting of small angle X-ray scattering data for various particle fractions.

FIG. 3 shows the radii of gyration and the scatter intensity of nanoparticles as a function of the fractionation time.

FIG. 4 shows curve fitting of small angle X-ray scattering data by means of cylinder scattering functions.

FIG. 5 shows the radii and lengths of the cylindrical nanoparticles as a function of the fractionation time.

FIG. 6 shows a comparison of the analysis of a fractionated nanoparticle sample by means of UV detection or small angle X-ray scattering.

FIG. 7 shows the frequency distribution of the nanocylinders as a function of the volumes and their masses.

The invention will be explained in further detail below, without being limited thereto.

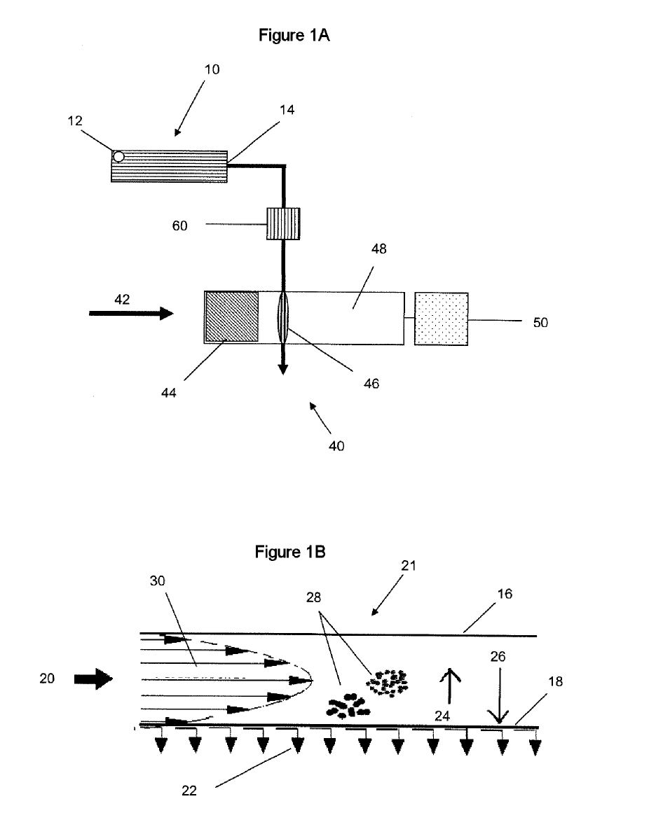

FIG. 1A shows a schematic illustration of an apparatus according to the invention. A device for field-flow fractionation 10 is connected to a device for small angle X-ray scattering 40. The nanoparticles are fractionated in the device for field-flow fractionation 10, which is configured here as an asymmetrical device for field-flow fractionation 10, by means of a cross flow 22, which is superposed on a main flow of the stream, a carrier stream 20, in the channel. The separation principle is shown schematically in FIG. 1B and will be explained in further detail below. The sample to be analyzed is applied by a sample injector 12 and separated. The nanoparticles leave the device for field-flow fractionation 10 once they are fractionated according to hydrodynamic sizes, specifically in the sequence, small, medium and large particles. The flow with the fractionated nanoparticles is guided from a fraction outlet 14 through a UV detector 60 and detected by means of UV absorption at a wavelength of 300 nm. Subsequently, the flow reaches a through-flow capillary 46 of the device for small angle X-ray scattering 40, which capillary is designed as a measurement chamber. The through-flow capillary 46 is positioned in a vacuum chamber 48. For the analysis of the nanoparticles, a synchrotron beam 42 is focussed through a slit collimator 44 onto the through-flow capillary 46. The scatter intensity of the sample is recorded by means of the detector 50. The delay between the detection in the UV detector 60 and the analysis in the device for small angle X-ray scattering 40 is about 140 s. The detection time in the device for small angle X-ray scattering 40 is 1 s.

FIG. 1B schematically shows the separation principle of asymmetrical field-flow fractionation. Characteristic of the asymmetrical field-flow fractionation is the separation of the nanoparticles according to their diffusion coefficients. The carrier stream 20 flows with a parabolic flow profile through a separation channel 21. The nanoparticles 28 are injected into the separation channel 21 and fractionated therein. In the process, the parabolic velocity profile of the carrier stream 20 transports the particles along the separation channel 21 in the direction of the fraction outlet 14. The particles are separated by way of a second cross flow 22, which flows perpendicular to the carrier stream 20. Said cross flow 22 leaves the channel through an ultrafiltration membrane, which forms a semipermeable channel lower side 18 of the separation channel 21. A channel upper side 16 of the separation channel 21 is not permeable. Owing to the cross flow 22, a cross force 26 acts on the sample particles in the direction of the semipermeable channel lower side 18. A diffusion force acts on the sample particles in the opposite direction. For smaller sample particles, the diffusion force 24 is greater than for larger particles, and as a result smaller sample particles are focussed in the center of the separation channel 21 and larger particles are focussed at the lower edge of the separation channel 21. Due to the parabolic flow profile of the carrier stream 20, small particles are thus transported more quickly and therefore eluted first, followed by the larger particles in descending order of diffusion coefficients. Retention time tᵣ is given by equation (1),

$${t}_{r} = \frac{{t}_{0} {v}_{c} {w}^{2}}{6 {DV}_{0}} , \qquad ( 1 )$$

wherein t₀ is the retention time of the solvent, v_{c} is the cross-flow rate, V₀ is the volume in the channel, w is the thickness of the channel and D is the diffusion coefficient of the separated nanoparticles.

### EXAMPLE 1

### Preparation of Nanoparticles

Maghemite nanoparticles were prepared in the manner of a known precipitation method according to Bee A. et al. (Bee A et al., Journal of Magnetism and Magnetic Materials, 149 (1-2), 6-9, 1995). A micromixer with two inlets for liquid streams was used (IMM GmbH, Mainz, Germany). The first stream was a mixture in aqueous solution of Fe(II)Cl₂4H₂O and Fe(III)Cl₃6H₂O (both Fluka, Germany) with a molar ratio of 2:1 of Fe(III) to Fe(II) with an overall content of iron of 0.13 mol L⁻¹ (7.1 g L⁻¹). Carboxydextran (Meijto Sangyo Co. Ltd., Japan) was added at a weight ratio of iron salts to carboxydextran of 1:3. The second stream was composed of 25% aqueous ammonium hydroxide solution. Liquid streams one and two were mixed in the volume ratio of 19 to 1. When the two liquid streams come together, magnetite nanoparticles are formed, which oxidize to maghemite nanoparticles in the presence of oxygen within a few days, as Mössbauer spectroscopy investigations using comparable samples showed (Thunemann A. F. et al., Langmuir 2006, 22, (5), 2351-2357). Carboxydextran is used as a polymeric stabilizer for preventing aggregation, thus imparting both long-term stability and biocompatibility on such nanoparticles.

### EXAMPLE 2

### Analysis of the Nanoparticles Using Dynamic Light Scattering

The measurements were carried out using a Malvern Particle Sizer Instrument (Zetasizer Nano ZS, Malvern Instruments, UK), equipped with a He—Ne laser (λ=632.8 nm). The scattering data were recorded at 298 K in backscattering modus at a scattering angle of 2θ=173°. This corresponds to a scattering angle of q=4πn/λ sin θ (0.02636 nm⁻¹). The aqueous dispersions were placed in 10×10 mm disposable cuvettes made from polystyrene. Before measurement, the samples were filtered through a 0.45 μm syringe filter for separating off any dust particles present. The hydrodynamic radius Rₕ (of a hydrodynamically equivalent sphere) was determined from the ascertained diffusion coefficient by means of the Stokes-Einstein relation Rₕ=kT/(6πηD). Here, the viscosity of water η=0.9387 mPa and a temperature of 296 K were used.

The nanoparticles prepared in example 1 were analyzed using dynamic light scattering. The intensity-weighted hydrodynamic radius is Rₕ=9.8 nm with a polydispersity index of PDI=0.15. The volume-weighted hydrodynamic radius is 6.3 nm. As a result, sizes and PDI are comparable with particles prepared using a batch process in the prior art (Bee A et al., Journal of Magnetism and Magnetic Materials, 149 (1-2), 6-9, 1995). Within the meaning of the ISO standard 13321 for dynamic light scattering, a PDI of greater than 0.1 already refers to widely distributed nanoparticles. The results obtained are therefore afflicted with an uncertainty factor. In addition, dynamic light scattering provides no information relating to the shape of the nanoparticles, and merely provides a rough idea of the size distribution.

### EXAMPLE 3

### Analysis of the Nanoparticles with a Combination of Field-Flow Fractionation and Small Angle X-Ray Scattering

Fractionation using a field-flow fractionation method provides nanoparticles with a narrow size distribution, which is ideal for analysis using small angle X-ray scattering. This is carried out online using a flow-through cell 46 and intensive synchrotron radiation 42 in an apparatus according to FIG. 1A.

Used as a device for field-flow fractionation 10 was the A4F unit for asymmetrical field-flow fractionation from Postnova Analytics GmbH (Germany), with an AF2000 focus system (PN 5200 sample injector, PN 7505 inline degasser, PN 1122 tip and focus pump). An inline solvent filter (100 nm, degenerated cellulose, Postnova) was connected between the focus pump and the channel to reduce the background. The thickness of the separation channel 21 was 500 micrometers, the ultrafiltration membrane on the semipermeable channel lower side 18 was a regenerated cellulose membrane with a cutoff of 10×10³ g mol⁻¹. The detector flow rate, i.e. the flow rate of the carrier stream 20, was 0.5 mLmin⁻¹.

The cross-flow rate was controlled by AF2000 software (Postnova Analytics). The cross flow 22 was decreased linearly with time, starting with a cross flow 22 of 2.5 mLmin⁻¹, decreasing at a rate of 2.5/70 mLmin⁻². The samples contained nanoparticles at a concentration of 0.71% by weight of iron, corresponding to 1.0% by weight of maghemite. In each case a sample volume of 0.02 mL was injected into the A4F 10. The fraction outlet 14 of the A4F 10 was connected directly to a UV detector 60, which detected at a wavelength of 300 nm, and to the flow-through cell 46 of the small angle X-ray scattering system 40. The particle stream with the fractionated particles arrived at the UV detector 60 about two minutes before it flowed through the flow-through cell 46 of the small angle X-ray scattering system 40.

Small angle X-ray scattering measurements were performed at the BAMline at Berliner Electron Synchrotron (BESSY, Berlin, Germany) with a Kratky-type instrument (SAXSess from Anton Paar, Austria). The SAXSess is characterized by a low sample-to-detector distance and has a slit focus geometry. The measured intensities were corrected by subtracting the scattering contribution of the capillary filled with water. The scattering vector is defined in terms of the scattering angle θ and the wavelength λ of the X-radiation used (λ=0.154 nm). Thus, q=4π/λ sin(θ/2). The influence of the slit-type collimation system 44 on the scattering curves was taken into account by deconvolution using software (SAXS-Quant software, version 2.0, Anton Paar).

### EXAMPLE 4

### Evaluation of the Small Angle X-Ray Scattering Data

Scattering of nanoparticles prepared in example 1 was observed in the time interval between 330 s and 1130 s. The scatter intensity of nanoparticles in diluted solution can be evaluated, for small q values, by way of a Guinier approximation. Guinier has shown that the scatter intensity of nanoparticles decreases exponentially and can be characterized by the radius of gyration R_{g} (Guinier, A., X-Ray Diffraction in Crystals, Imperfect Crystals, and Amorphous Bodies. Dover Publications, INC.: New York, 1994). The approximation is typically used in linearized fashion according to equation (2) for determining R_{g} and the intensity for q=0.

$$ln [ I ( q ) ] = ln [ I ( 0 ) ] - \frac{1}{3} {R}_{g}^{2} {q}^{2} \qquad ( 2 )$$

The ln [I(q)] of an experimental scattering curve is shown here as a function of q². As long as a straight line can be fitted to the data, the gradient of this straight line is

$$\frac{1}{3} {R}_{g}^{2}$$

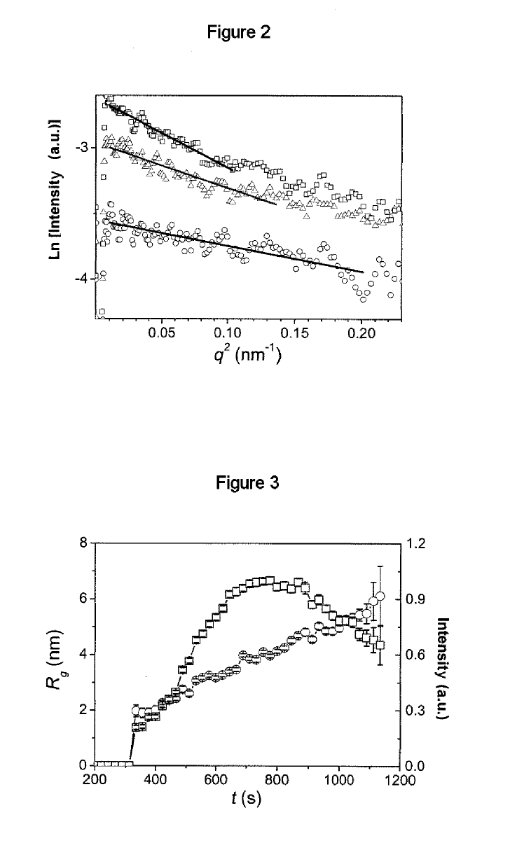

and the intersection with the ordinate is ln [I(0)]. It should be noted that Guinier approximation can be used only for small values of q R_{g}. In practice, reliable fitting for values in the q range of q R_{g}≦1.3 are observed (Svergun, D. I. and Koch, M. H. J., Reports on Progress in Physics 2003, 66, (10), 1735-1782). For the Guinier approximations in this example, the q range was selected such that q R_{g}≦1.2. FIG. 2 shows, by way of example, Guinier-fitted curves (solid lines) for small angle X-ray scattering data for t=444 s, (R_{g}=2.42 nm, circles), t=644 s (R_{g}=3.39 nm, triangles) and t=778 s (R_{f}=4.13 nm, squares).

FIG. 3 gives an overview of the radii of gyration (circles) thus determined and small angle X-ray scattering intensities I(0) (squares, from extrapolation with q=0 by means of Guinier approximation) as a function of the fractionation time. For the sake of clarity, only every tenth data point is shown. It can be seen that the first and smallest nanoparticles are detected at t=330 s (R_{g}=1.97 nm). The maximum of the intensity can be found for particles of medium size at 770 s (R_{g}=3.96 nm). The largest particles are detected at 1130 s (R_{g}=6.11 nm).

### EXAMPLE 5

### Determination of the Morphology of Nanoparticles

The Guinier approximation is easy to use for a large number of small angle X-ray scattering data, but does not permit any direct statement relating to the shape of the nanoparticles to be made. One established method for determining the shape of the particles is the fitting of model functions to the experimental scattering curves. A detailed overview in this respect was compiled for example by Pedersen (Pedersen, J. S., Advances in Colloid and Interface Science 1997, 70, 171-210). The scatter intensity of diluted nanoparticles is given by the form factor P(s). In the present example, the nanoparticles are present already in diluted form at injection into the device for field-flow fractionation 10 (iron content of 7.1 g/L). They are further diluted by the fractionation by a factor of about 100 to an iron content of about 0.07 g/L.

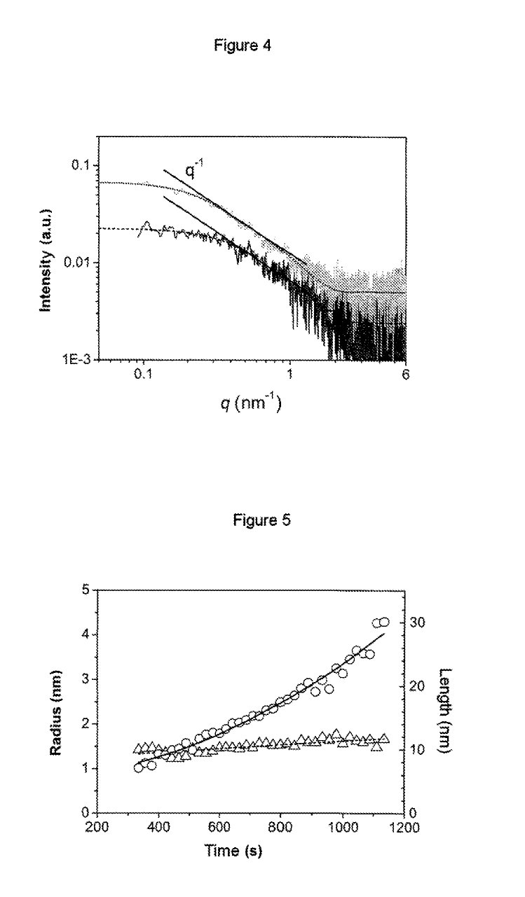

FIG. 4 shows the small angle X-ray scattering curves of two fractions of nanoparticles. The lower curve, shown in black, shows the scatter intensities of the particle fraction at 444 s, the upper, grey curve shows the scatter intensities of the particle fraction at 777 s. The measurement time for a scattering curve was 1 s. The scatter intensity of the measurements is scaled with q⁻¹ in the middle q range in the range of 0.5<q<1.0 nm⁻¹, as is shown by the straight lines in the double logarithmic illustration. This profile is typical for cylindrical and rod-shaped nanoparticles. The scattering curves are therefore fitted using a cylinder model. The scatter intensity of a cylinder with radius R and length L is given by equation (3) (Pedersen, J. S., Advances in Colloid and Interface Science 1997, 70, 171-210):

$$I ( q ) = \frac{{k ( ρ - {ρ}_{s} )}^{2}}{V} {\int }_{0}^{π / 2} {[ \frac{2 {J}_{1} ( qR sin α )}{qR sin α} \frac{sin ( \frac{1}{2} qL cos α )}{\frac{1}{2} qL cos α} ]}^{2} sin α d α , \qquad ( 3 )$$

wherein k is a scaling factor, ρ and ρₛ are the electron density of the cylinder and water, and V is the cylinder volume. In this case, the electron density of the cylinder is assumed to be constant. Thus, R=1.22 nm and L=9.87 nm for the fraction at t=444 s (FIG. 4, dashed line) and R=1.52 nm and L=16.43 nm for the fraction at t=777 s (FIG. 4, dotted line). The curves fitted using the cylinder model have a high degree of correspondence with the measurement curves. Particular attention should be paid to the high data quality for the short measurement time of 1 s.

The cylinder radii (left-hand ordinate) and cylinder lengths (right-hand ordinate) resulting from the curve fitting are shown in FIG. 5 together as a function of the fractionation time. The error bars are here smaller than the size of the symbols and therefore cannot be shown. It can be seen that the cylinder radii vary between 1.2 nm and 1.7 nm. The slight increase in the radii (triangles) with time is approximately linear and can be fitted by a straight line of the formula R(t)=1.19 nm+4.3×10⁻⁴ nm s⁻¹×t (dashed line). Contrary to the radii, the length (circles) of the cylinders increase drastically with the fractionation time. The smallest length is 7 nm at t=333 s, the longest length 30 nm at t=1133 s. The increase in cylinder lengths can be described by a second-order polynomial as L(t)=5.55 nm+1.78×10⁻³ nm s⁻¹×t+1.61×10⁻⁵ nm s⁻²×t² (FIG. 5, solid line).

### EXAMPLE 6

### Comparison of the Analysis Results by Means of UV Detection and Small Angle X-Ray Scattering

The size distribution of nanoparticles is of great analytical interest, in particular when assessing the quality of the nanoparticles, their risk potential and for the systematic improvement of their preparation.

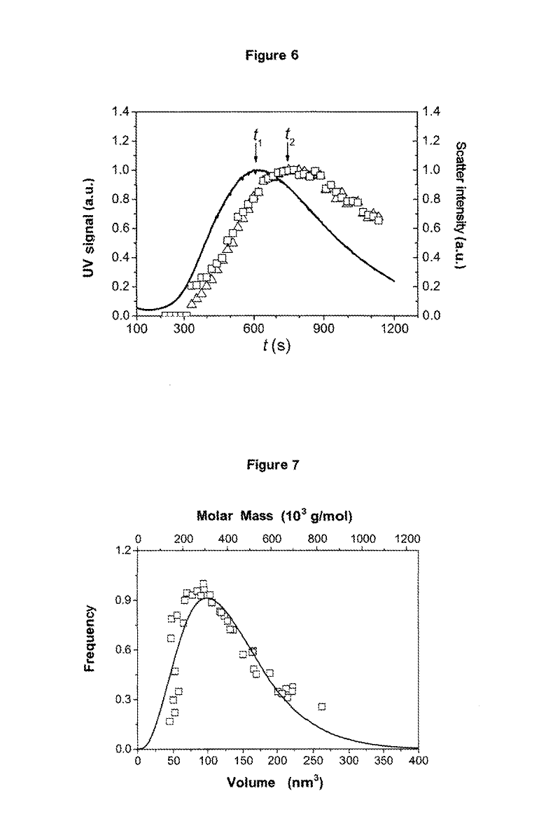

The detection method used most widely for field-flow fractionation is UV detection, which can be used quickly and cost-effectively in the online method but gives no structural information at all. FIG. 6 shows the results of the measurement of the UV absorption of a fractiogram of superparamagnetic nanoparticles at a wavelength of 300 nm (left-hand ordinate, solid line). The same fractiogram was investigated using small angle X-ray scattering. The scatter intensities are likewise shown in FIG. 6 (right-hand ordinate). The scatter intensities were ascertained by means of Guinier fitting (squares) and from the scaling factors of the curve fittings to the cylinder model by means of equation (3) (triangles). The maximum of the UV signal is at t₁=610 s, the maximum of the scatter intensity at t₂=750 s. The maxima are normalized to one. It can be seen that the shape of the curve of the UV absorption and that of the scatter intensity as a function of time are very similar. The fundamental difference is a time delay between the maxima of the UV curve and the small angle X-ray scattering curve. The reason for the difference between t₂ and t₁ is the time it takes the liquid stream to flow from the UV detector (first detector system) to the device for small angle X-ray scattering 40 (second detector system).

### EXAMPLE 7

### Determination of the Distribution of the Volumes and Molar Masses of the Nanoparticles

The volume distribution of the nanoparticles can be calculated from known scatter intensities, nanocylinder radii and nanocylinder lengths. Moreover, it is possible to determine the molar mass distribution by multiplying the volume by the solid density of maghemite (4.89 g cm⁻³) and the Avogadro constant. FIG. 7 shows the results of the calculation of the volume distribution (lower X-axis) and the molar mass distribution (upper X-axis). It can be seen that the smallest nanoparticles have a volume of 45 nm³ and contain about 1650 iron atoms. Their molar mass is M=1.4×10⁵ g mol⁻¹. The maximum of the volume distribution is at a volume of 97 nm³. This corresponds to 3560 iron atoms and a molar mass of M=3.0×10⁵ g mol⁻¹. The largest nanocylinders have a volume of 263 nm³ and contain 9640 iron atoms (M=8.2×10⁵ g mol⁻¹). The ascertained number of iron atoms represents an upper limit since it can be assumed that the density of maghemite in the nanocylinders is lower than in the expanded solid. A large number of atoms are located, in the case of the nanocylinders, on the particle surface, which reduces the density. More accurate values for determining the molar masses can be ascertained according to Orthaber et al. (Orthaber, D. et al., O., Journal of Applied Crystallography 2000, 33, 218-225).

Suitable for the quantitative description of the volume distribution are a wide variety of distribution functions, which must be adapted in each case for the specific problem. Suitable here is the Schulz-Zimm distribution in the form of equation (4) for the quantitative description,

$${h}_{2} ( V ) = \frac{{( z + 1 )}^{z + 1} {V}^{z}}{{〈 V 〉}^{z + 1} Γ ( z + 1 )} exp [ - ( z + 1 ) \frac{V}{〈 V 〉} ] \qquad ( 4 )$$

wherein <V> is the average volume. The standard deviation σ=(z+1)^{-1/2} determines the width of the distribution. FIG. 7 shows the corresponding curve fitting according to the Schulz-Zimm distribution (solid line). The median of the volume of the nanoparticles is 99±3 nm³ and the width is σ=0.50.

### LIST OF REFERENCE SIGNS

10 device for field-flow fractionation
12 sample injector
14 fraction outlet
16 non-permeable channel upper side
18 semipermeable channel lower side
20 carrier stream
21 separation channel
22 cross flow
24 diffusion force
26 cross force
28 sample particles
30 parabolic flow profile
40 device for small angle X-ray scattering
42 synchrotron beam
44 slit collimator
46 through-flow capillary
48 vacuum chamber
50 detector
60 UV detector

1. A method for analyzing nanoparticles, comprising:
fractionation of the nanoparticles to be analyzed as a function of their particle size,
immediately following, an analysis of the nanoparticles using small angle X-ray scattering,
wherein the analysis by means of small angle X-ray scattering comprises:
focusing of X-radiation onto the nanoparticles to be analyzed by means of a slit collimator, and
analysis of the nanoparticles using a detector-to-sample distance of less than 50 cm.

2. The method as claimed in claim 1, wherein the fractionation of the nanoparticles and/or the subsequent analysis are carried out continuously.

3. The method as claimed in claim 1, wherein the nanoparticles are divided as a function of their diffusion coefficients.

4. The method as claimed in claim 1, wherein the fractionation is effected by means of field-flow fractionation.

5. The method as claimed in claim 1, wherein parameters comprising size, mass, form, number, material composition, internal structure and/or coating are investigated for the analysis of the nanoparticles.

6. The method as claimed in claim 1, wherein interactions between the nanoparticles are analyzed.

7. The method as claimed in claim 1, wherein monochromatic X-radiation with a photon energy of 5 keV to 80 keV, preferably of 8 keV to 15 keV, particularly preferably synchrotron radiation is used as X-radiation.

8. The method as claimed in claim 1, wherein the measurement time of the analysis of a fraction is less than 10 seconds, preferably less than 1 second.

9. The method as claimed in claim 1, wherein a material of the nanoparticles is selected from inorganic and organic materials and composites of both, synthetic and natural materials and composites of both, in particular proteins and their composites with the aforementioned materials.

10. The method as claimed in claim 1, wherein the nanoparticles have a size of 1 to 300 nm, preferably of 1 to 100 nm and particularly preferably of 1 to 50 nm.

11. An apparatus for analyzing nanoparticles, comprising:
a device for fractionating the nanoparticles as a function of their particle size, and
a device, connected downstream, for analyzing the nanoparticles, wherein the device for analysis is a device for measuring small angle X-ray scattering,
wherein a detector-to-sample distance in the device for measuring small angle X-ray scattering is less than 50 cm and
the device for measuring small angle X-ray scattering has a slit collimator.

12. The apparatus as claimed in claim 11, wherein the device for fractionating the nanoparticles as a function of the particle size is a device for fractionating as a function of the diffusion coefficient, preferably a device for field-flow fractionation.

13. The apparatus as claimed in claim 11, wherein the device for measuring small angle X-ray scattering has a through-flow capillary configured as a measurement chamber.

14. The apparatus as claimed in one of claims 11, wherein the device for measuring small angle X-ray scattering has a means for monochromatization of X-rays, preferably a Goebel mirror.

15. The apparatus as claimed in one of claims 11, wherein a UV detector is positioned between the device for fractionating and the device for measuring small angle X-ray scattering.
